(19) United States
(12) Patent Application Publication
(10) Pub. No.: US 2005/0104398 A1
(43) Pub. Date: May 19, 2005

(54) Rail vehicle wheel, and a corresponding rail vehicle bogey

(75) Inventor: Jean-Daniel Nast, Le Creusot (FR)

Correspondence Address: SUGHRUE MION, PLLC, 2100 PENNSYLVANIA AVENUE, N.W., SUITE 800, WASHINGTON, DC, 20037, US

(73) Assignee: ALSTOM

(21) Appl. No.: 10/981,570

(22) Filed: Nov. 5, 2004

(30) Foreign Application Priority Data
Nov. 14, 2003 (FR) 03 13346

(51) Int. Cl. B60C 17/04

(52) U.S. Cl. 295/34

(57) ABSTRACT

The wheel which is for use with a rail presenting an angle of inclination of 1/20, includes a running zone for coming into contact with the rail, a lateral flange projecting radially outwards from the tread, and a link portion presenting conicity that increases continuously going towards the flange. In cross-section, the running zone presents a straight segment of conicity lying in the range 0.052 to 0.058, thereby ensuring satisfactory self-centering for the rail vehicle.

The present invention relates to a rail vehicle wheel, and also to a rail vehicle bogey including such wheels.

### BACKGROUND OF THE INVENTION

In conventional manner, a rail vehicle wheel comprises a peripheral tread which is provided with a running zone for coming into contact with a corresponding rail. It is also provided with a lateral flange placed on the inside which projects radially relative to the above-mentioned tread. Such a flange serves in particular to provide a guidance function, in the sense that the presence of the tread serves to prevent the rail vehicle from derailing.

The above-mentioned running zone presents a profile that is generally frustoconical, of diameter that increases progressively going towards the flange. A link portion is also provided connecting the running zone to the flange. In cross-section, this link portion is of a shape that is curved in that its diameter increases more quickly than the diameter of the running zone.

A rail vehicle wheel of the above-described type is known, e.g. from EP-A 0 008 538. According to the teaching of that document, the diameter of the tread beside the track increases continuously going towards the link portion, with the rate of increase in the diameter of said tread nevertheless decreasing going towards said link portion.

### OBJECTS AND SUMMARY OF THE INVENTION

That said, the present invention proposes providing a rail vehicle wheel which offers comfort that is increased compared with previously developed wheels present in the prior art.

To this end, the invention provides a rail vehicle wheel for use on a rail presenting an angle of inclination of 1/20, said wheel including a peripheral tread comprising a running zone for coming into contact with the rail, said running zone presenting, in cross-section, a straight segment, the wheel further including a lateral flange projecting radially outwards from the tread, and a link portion connecting the straight segment to the flange via a point of inflection, said link portion presenting conicity which increases continuously going towards the flange, wherein the conicity of said straight segment lies in the range 0.052 to 0.058.

According to other characteristics of the invention:
the conicity of the straight segment lies in the range 0.054 to 0.056, and in particular is equal to 0.055;
the distance between the link portion and the middle of a straight line segment passing through the two ends of said link portion lies in the range 2.90 mm to 3.10 mm;
said distance lies in the range 2.95 mm to 3.05 mm, and in particular is equal to 3.00 mm;
the distance between a running line and the end of the straight segment adjacent to the flange lies in the range 8.90 mm to 9.30 mm, and preferably in the range 9.00 mm to 9.20 mm;
said distance is equal to 9.10 mm;
the angle between a tangent to the point of inflection and a straight line parallel to the main axis of the wheel and passing through a running line of the wheel, lies in the range 68.10° to 68.70°, and preferably in the range 68.30° to 68.50°; and
said angle is equal to 68.40°.

The invention also provides a rail vehicle bogey comprising a frame and wheels mounted on axles supporting the frame, wherein each wheel is as defined above.

### BRIEF DESCRIPTION OF THE DRAWING

The invention is described below with reference to the accompanying drawing given purely by way of non-limiting example, in which the sole FIGURE is a diametral section view showing a rail vehicle wheel in accordance with the invention.

### MORE DETAILED DESCRIPTION

The sole FIGURE shows a rail vehicle wheel 2 in accordance with the invention which is designed to travel on a rail (not shown), in conventional manner. In accordance with the invention, the rail presents an inclination of 1/20, i.e. one part in twenty in the conventional “cant” meaning as used in the technical field of laying track.

The wheel 2 possesses a main axis (not shown) which in this case is horizontal. It is also provided with a peripheral tread, given overall reference 6.

This tread 6 comprises a running zone 8 extending on either side of a peripheral running line 10. The running line is formed in conventional manner by the set of points of contact made by the wheel 2 with the rail when the wheel is in its central position, corresponding to normal running. Reference Y designates the horizontal straight line passing through said running line 10.

On the inside, the wheel 2 is also provided with a flange 12 projecting radially from the tread 6. In known manner, the presence of the flange 12 provides a function of guiding the wheel so as to avoid the rail vehicle derailing.

A link portion 14 is also provided, connecting the running zone 8 to the flange 12. The curved profile of this link portion 14 is described in greater detail below.

A link portion 14 is also provided, connecting the running zone 8 to the flange 12. The curved profile of this link portion 14 is described in greater detail below.

Finally, the wheel 2 is provided, opposite from the flange 12, with a lateral portion 16 extending the running zone 8. This portion 16 tapers in conventional manner going away from the flange 12, and it presents a slope that is steeper than the slope of the running zone 8.

In cross-section, the running zone 8 possesses a straight segment 8A extending along straight line X of a constant slope that is close to 5.5% in the example described. This means that the ratio (D₂−D₁/L) of the difference between the end diameters D₂ and D₁ of the segment 8A divided by the distance L between them, as measured along the main horizontal axis of the wheel, is equal to 0.055. This also means, in other words, that the conicity of the segment 8A is 0.055.

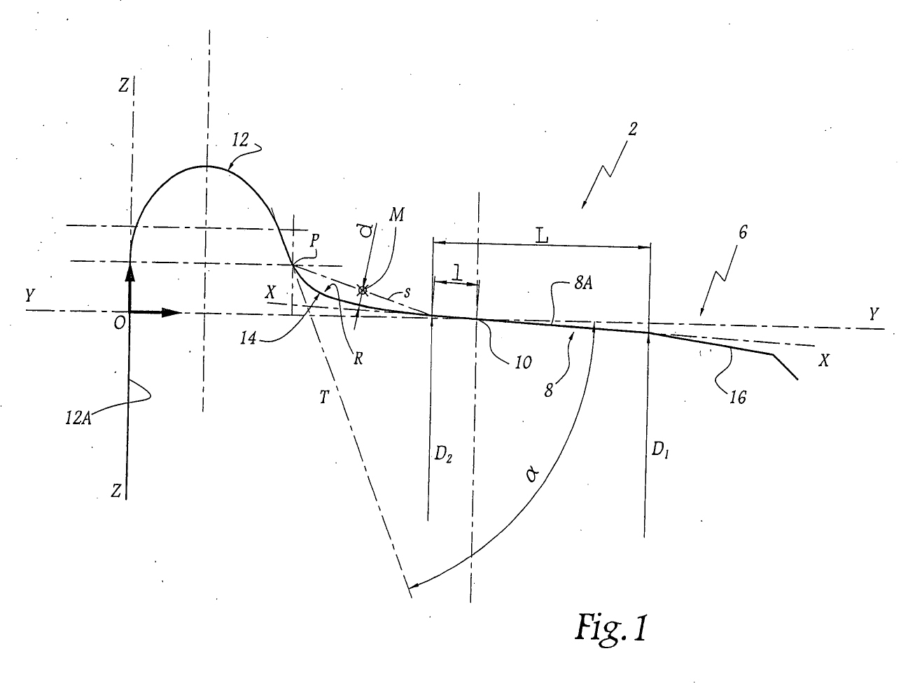

This value of 0.055 is naturally given in non-limiting manner with reference to the example of FIG. 1. The conicity of this segment 8A could also be provided to present values other than that mentioned above, and it advantageously lies in the range 0.052 to 0.058, and preferably in the range 0.054 to 0.056.

In the example shown, the distance l separating the running line 10 from the end of the segment 8A adjacent to the flange 14 is equal to 9.10 millimeters (mm). In a variant, the distance l lies in the range 8.90 mm to 9.30 mm, and preferably in the range 9.00 mm to 9.20 mm.

The link portion 14 connects the facing ends of the straight segment 8A and the flange 12. It is connected to the flange by a point of inflection referenced P. It should also be observed that the tangent to the above-mentioned curve at the point of inflection is referenced T.

It should be observed that the above-defined conicity of the link portion 14 increases continuously from the straight segment 8A towards the flange 12. The slope of this link portion 14 thus increases starting from a value of 5.5% where it runs into the straight segment 8A.

The straight line segment interconnecting the two ends of the link portion 14 where it joins the straight segment 8A and the flange 12 respectively is referenced S. The middle of this segment S is referenced M and the distance between the middle M and the link portion 14 is referenced d.

In the example shown, this distance d is equal to 3.00 mm. Nevertheless, provision could be made for this distance to present values other than those mentioned above. Thus, it advantageously lies in the range 2.90 mm to 3.10 mm, and preferably in the range 2.95 mm to 3.05 mm.

Furthermore, the angle α between the tangent T and the horizontal straight line Y is close to 68.40° in the example shown. This angle α advantageously lies in the range 68.10° to 68.70°, and preferably in the range 68.30° to 68.50°.

In the prior art, in accordance with the teaching of above-mentioned EP-A-0 008 538, the straight segment of the running zone of the wheel presents conicity that is smaller than that of the segment 8A of the invention. More precisely, in this particular zone, the prior art wheel presents conicity close to 0.05.

The existence of conicity that is greater confers substantial advantages of the wheel of the invention. The wheel is thus itself capable, in a manner that is more satisfactory than in the prior art, of opposing the transverse movements to which the rail vehicle is subjected, thereby guaranteeing rapid self-centering of the vehicle.

Furthermore, it should be observed that the straight line in a prior art wheel interconnecting the two ends of the link portion is further away from said link portion than in the invention. In other words, the distance between this straight line and the link portion is considerably greater than the distance d separating the link portion 14 from the segment S in the invention.

Consequently, the link portion 14 of the wheel 2 of the invention defines a setback referenced R in the FIGURE which is shallower than that which exists in the prior art. This measure is advantageous, given that during transverse movement of the wheel it prevents the flange 12 from hitting hard against the facing side of the rail. This serves to guarantee satisfactory comfort for the passengers of the vehicle.

By way of non-limiting example, the coordinates of the points forming the profile of the wheel of the invention are given below. The abscissa axis coincides with above-mentioned straight line Y, while the ordinate axis is constituted by the straight line Z perpendicular to Y and passing via the side 12A of the flange 12.

Under these conditions, the origin of the coordinates is the point O corresponding to the point of intersection between the above-mentioned lines Y and Z, with the abscissa Y increasing towards the right in FIG. 1, while the ordinate Z increases upwards in the same FIGURE. The following table gives specifically the coordinates of points in the flange 12 and the link portion 14.

| Y | Z |
|---|---|
| 3.272 | 21.631 |
| 4.156 | 22.776 |
| 5.040 | 23.879 |
| 5.924 | 24.897 |
| 6.808 | 25.788 |
| 7.692 | 26.535 |
| 8.576 | 27.152 |
| 9.460 | 27.656 |
| 10.345 | 28.063 |
| 11.229 | 28.389 |
| 12.113 | 28.642 |
| 12.997 | 28.826 |
| 13.881 | 28.942 |
| 14.765 | 28.994 |
| 15.649 | 28.984 |
| 16.533 | 28.913 |
| 17.417 | 28.774 |
| 18.301 | 28.561 |
| 19.185 | 28.266 |
| 20.069 | 27.882 |
| 20.953 | 27.403 |
| 21.838 | 26.827 |
| 22.722 | 26.158 |
| 23.606 | 25.400 |
| 24.490 | 24.555 |
| 25.374 | 23.619 |
| 26.258 | 22.566 |
| 27.142 | 21.371 |
| 28.026 | 20.003 |
| 28.910 | 18.406 |
| 29.794 | 16.500 |
| 30.678 | 14.281 |
| 31.562 | 12.068 |
| 32.447 | 10.206 |
| 33.331 | 8.723 |
| 34.215 | 7.542 |
| 35.099 | 6.590 |
| 35.983 | 5.827 |
| 36.867 | 5.216 |
| 37.751 | 4.722 |
| 38.635 | 4.311 |
| 39.519 | 3.960 |
| 40.403 | 3.660 |
| 41.287 | 3.400 |
| 42.171 | 3.169 |
| 43.056 | 2.957 |
| 43.940 | 2.756 |
| 44.824 | 2.566 |
| 45.708 | 2.386 |
| 46.592 | 2.216 |
| 47.476 | 2.055 |
| 48.360 | 1.903 |
| 49.244 | 1.761 |
| 50.128 | 1.626 |
| 51.012 | 1.500 |
| 51.896 | 1.381 |

1. A rail vehicle wheel for use on a rail presenting an angle of inclination of 1/20, said wheel including a peripheral tread comprising a running zone for coming into contact with the rail, said running zone presenting, in cross-section, a straight segment, the wheel further including a lateral flange projecting radially outwards from the tread, and a link portion connecting the straight segment to the flange via a point of inflection, said link portion presenting conicity which increases continuously going towards the flange, wherein the conicity (D₂−D₁/L) of said straight segment lies in the range 0.052 to 0.058.

2. A wheel according to claim 1, wherein the conicity (D₂−D₁/L) of the straight segment lies in the range 0.054 to 0.056, and in particular is equal to 0.055.

3. A wheel according to claim 1, wherein the distance between the link portion and the middle of a straight line segment passing through the two ends of said link portion lies in the range 2.90 mm to 3.10 mm.

4. A wheel according to claim 3, wherein said distance lies in the range 2.95 mm to 3.05 mm, and in particular is equal to 3.00 mm.

5. A wheel according to claim 1, wherein the distance between a running line and the end of the straight segment adjacent to the flange lies in the range 8.90 mm to 9.30 mm, and preferably in the range 9.00 mm to 9.20 mm.

6. A wheel according to claim 5, wherein said distance is equal to 9.10 mm.

7. A wheel according to claim 1, wherein the angle between a tangent to the point of inflection and a straight line parallel to the main axis of the wheel and passing through a running line of the wheel, lies in the range 68.10° to 68.70°, and preferably in the range 68.30° to 68.50°.

8. A wheel according to claim 7, wherein said angle is equal to 68.40°.

9. A rail vehicle bogey comprising a frame and wheels mounted on axles, and supporting the frame, wherein each wheel is in accordance with claim 1.
